(19) United States
(12) Patent Application Publication
(10) Pub. No.: US 2008/0062840 A1
(43) Pub. Date: Mar. 13, 2008

(54) METHOD AND APPARATUS FOR DETECTING OPTICAL DISK TYPE

(75) Inventors: Kim Hee NG, Singapore (SG); Norio HATANAKA, Kyoto (JP)

Correspondence Address: GREENBLUM & BERNSTEIN, P.L.C., 1950 ROLAND CLARKE PLACE, RESTON, VA, 20191, US

(73) Assignees: MATSUSHITA ELECTRIC INDUSTRIAL CO., LTD., Osaka (JP); PANASONIC SEMICONDUCTOR ASIA PTE., LTD., Singapore (SG)

(21) Appl. No.: 11/531,366

(22) Filed: Sep. 13, 2006

(51) Int. Cl. G11B 27/36

(52) U.S. Cl. 369/53.34

(57) ABSTRACT

A method to determine the diameter and shape of the loaded optical disk without any additional sensor. By accelerating a disk for a certain period of time and then monitoring the rotational speed before the spindle lock, the diameter and shape of the loaded optical disk is detected.

### BACKGROUND OF THE INVENTION

1. Field of the Invention

The present invention relates to a method and apparatus for detecting a type of a disk and, more particularly, to a method and apparatus for detecting a type of a disk by detecting a diameter of the disk.

2. Description of the Related Art

In common, CD (compact disc) comes with 2 types of diameter: 8 cm and 12 cm. However, there are some special shape of CD can be found in the current market such as square or diamond shape. In certain condition, the spindle acceleration force during accelerating the disk, spindle servo gain during play and braking force during stopping the disk is greatly depend on the diameter and the shape of the loaded disk to achieve optimum performance of the disk drive.

i) When accelerating the disk, to prevent long spindle Jock time, the accurate spindle acceleration force setting is required. Therefore this invention is able to set to optimum acceleration force after the first detection and apply accurate acceleration force in the later process of acceleration.

ii) When the disk is played, to prevent the sound quality from getting adversely effected by diameter and shape difference, the gain of the spindle servo of the disk drive must be set to optimum values.

iii) When stopping the disc, to prevent long braking time and reverse spin condition from happening, it is desirable to set the spindle braking force accurately depending on the diameter and shape of the disk.

Therefore it is important to determine the diameter and shape of every disk loaded for data reproduction. This invention is about a method that is able to determine the diameter and shape of the loaded optical disc in a short period of time without using any additional component such as optical sensor. The rotational speed of the disk after accelerating for a certain period of time is different if the mass and the diameter of the disk is different. Therefore, this invention is realized by monitoring the rotational speed of the disk just after accelerating for a certain period of time.

### SUMMARY OF THE INVENTION

It is an object of the present invention to provide ability to a disk drive that is capable to determine the diameter and shape of the disk which is loaded in a short time without using any additional component such as the optical sensor This invention consists of: CD data clock signal detection means for detecting the CD data clock signal during data reproduction from the disk; acceleration means for accelerating the disk with pre-determined acceleration force for a certain period of time from static condition so that the disk achieve certain rotational speed; CD data clock signal count means for counting the number of CD data clock signal to determine the rotational speed of the disc after acceleration means; microcomputer means for CD data clock signal detection means and counting the CD data clock signal count means which built-in in the CD signal processing unit or externally connected to the CD signal processing unit; disk diameter and shape determination means for determining the diameter and shape of the disk by comparing the counting of CD data clock signal count means with a reference value.

From stationary (disc not rotating), acceleration means accelerates the disk with pre-determined acceleration force for a certain period of time so that the disk achieve a certain rotational speed. And then turn on the servo so that the CD data clock signal detection means during data reproduction from the disk can be started by a microcomputer means. The microcomputer means will be counting CD data clock signal count means to count the number of CD data clock signal to determine the rotational speed of the disc after acceleration means. After a certain short period of time, the counting of the CD data clock signal will be stopped and CD data clock signal count means will be compared with a reference value. When the disk diameter is large, the CD data clock signal count means will be lower than the reference value. This is because the rotation speed of the disc is lower for larger diameter disk just after the acceleration means, When the disk diameter is small, the CD data clock signal count means will be higher than the reference value. This is because the rotation speed of the disc is higher for smaller diameter disk just after the acceleration means. With disk diameter and shape determination means for determining the diameter and shape of the disk by comparing the counting of CD data clock signal count means with a reference value, the spindle acceleration force means force to accelerates the spindle motor, spindle servo gain means gain of the spindle servo during play and spindle braking force means force to stop the disk can be set based on the result of the disk diameter and shape determination means.

The advantages of this invention are as following:

i) Eliminate the use of additional component such as optical sensor for disk diameter and shape determination means

ii) Fast detection. The disk diameter and shape determination means can be done just after the disk acceleration means which is the very early stage of the disk playing.

iii) Easy to implement without interrupting the normal initialization of disk drive when playing a disk. The microcomputer means is just act to monitor and detect the CD data clock signal count means. No complicated process and routine is needed for the implementation.

iv) Once the disk diameter and shape determination means is completed, the spindle lock time can be minimized due to the acceleration force is set correctly and therefore shorter time taken before the audio sound can be output.

v) The disk diameter and shape determination means enable accurate and fast braking operation and no reverse spin condition is found due to the braking force is set correctly.

### BRIEF DESCRIPTION OF THE DRAWINGS

FIG. 1 is a block diagram of a compact disk (CD) player which acts as the preferred embodiment of this invention.

FIG. 2 shows a block diagram of spindle servo processing unit in the preferred embodiment.

FIG. 3 is a block diagram showing the implementation of this invention in the preferred embodiment

FIG. 4 shows the spindle acceleration timing and operation timing for 12 cm disk according to the preferred embodiment.

FIG. 5 shows the spindle acceleration timing and operation timing for 8 cm disk according to the preferred embodiment.

### DESCRIPTION OF THE PREFERRED EMBODIMENTS

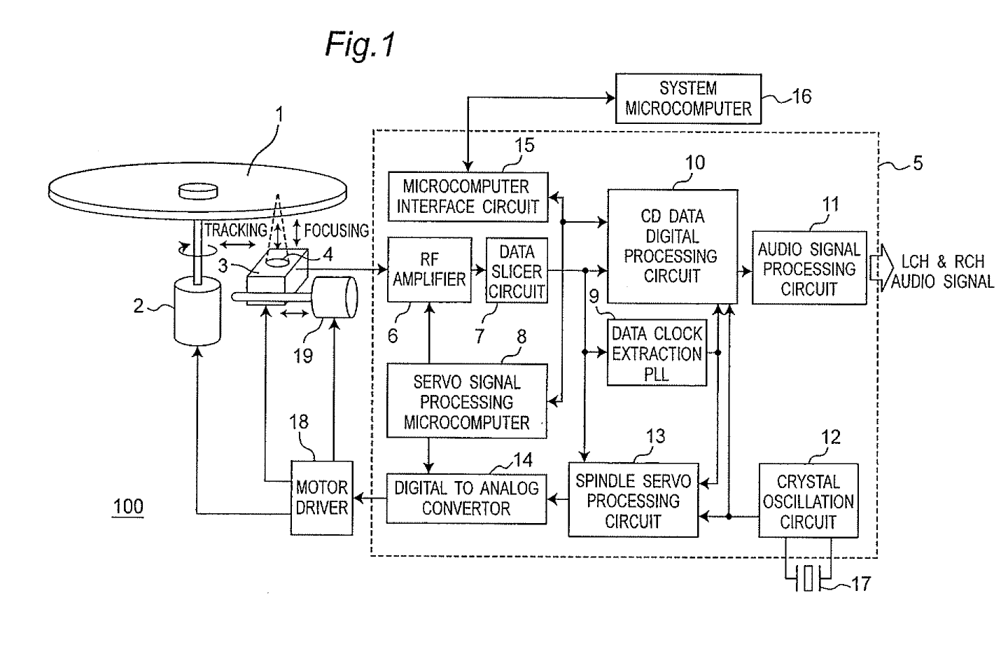

The following will describes one embodiment of the present invention which is a CD player 100. FIG. 1 is a block diagram of a CD player 100 which acts as the preferred embodiment of this invention

The CD player 100 has a spindle motor 2 which spins a CD (Compact Disc) 1 while playing at a constant linear velocity (CLV); at the same time an optical pick up unit 3 (hereinafter also called OPU) reads out the data recorded on the CD 1 using a laser beam. An objective lens 4 is provided on the OPU 3 which focuses the laser beam on to the CD 1, so that the reading process can be taken place by a laser spot generated. The objective lens 4 is controlled by a focus coil and a tracking coil (not shown in the diagram) to adjust the lens position. The focus coil controls the objective lens 4 in vertical direction while the tracking coil controls the horizontal direction so that laser spot can be placed correctly with respect to the recording track on the CD 1. A traverse motor 19 moves the optical pick up unit 3 horizontally across the CD 1. The amount of light reflected from the recording surface of the CD 1 is converted to electrical signal in the OPU 3.

The CD player 100 has a digital signal processor 5 (hereinafter also called DSP) to process the electrical signal output from OPU 3. The DSP 5 comprises an RF amplifier 6 and a data slicer circuit 7 as frontend processing. By making use of the signal from the OPU 3, the RF amplifier 6 generates required signals for further processing—servo processing signal and CD data processing signal. The servo processing signal which includes focus error and tracking error signal is sent to servo signal processing microcomputer 8. The focus error and tracking error signal is sampled digitally. By the use of these samples, a corrective drive signal is produced for respective three servo systems in the OPU 3, which are the focus servo system that maintains the focusing of the reading spot of the laser beam on the recording surface of the CD 1, the tracking servo system that makes sure that the reading spot is following on the recording track on the CD 1, and the traverse servo system that controls the position of the OPU 3 across the CD 1 horizontally. The corrective drive signal which is in digital format is fed to a digital to analog converter 14 (or it can be a pulse width demodulation circuit) where the analog signal is produced and fed to a motor driver 18 to drive the respective coil and traverse motor 19 to correct the error signal.

The CD data processing signal which is the CD data recorded on the CD 1 is sent to Data slicer circuit 7 where it is converted to a digital RF signal (hereinafter also called EFM signal).

The DSP also has a CD data digital processing circuit 10 and a data clock extraction PLL 9. The CD data digital processing circuit 10 processes the EFM signal from data slicer circuit 7 to produce the digital audio signal from CD data. The data clock extraction PLL 17 reproduces the CD data clock signal (hereinafter also called PCK signal) based on the edges of the EFM signal. The PCK signal represents the disk speed because the frequency of the PCK signal is proportional to the data rate of the EFM signal which represents the linear velocity of the CD 1 while rotating. When the linear velocity becomes high, the data rate of the EFM signal becomes high, and therefore, clock frequency of the PCK signal becomes high. An audio signal processing circuit 11 converts the digital audio signal to analog audio signal and produces left and right channel audio signals. A microcomputer interface circuit 15 provides a communication interface between the various circuits in DSP 5 and the external system microcomputer 16.

In additional, a crystal oscillation circuit 12, in which a external crystal oscillator 17 is connected to provide the reference clock signal to relevant circuit block such as CD data digital processing circuit 10 and spindle servo processing circuit 13.

A Spindle servo processing circuit 13 is incorporated in the DSP 5 to control rotational speed of the spindle motor 2. The spindle servo processing circuit 13 receives the PCK signal (data rate of the EFM signal) and a reference clock signal from crystal oscillation circuit 12, and produces a corrective drive signal in digital format (for example pulse width modulation signal) for adjusting the PCK signal (data rate of the EFM signal). Thus, the rotational speed of the CD 1 is adjusted with reference to the reference clock signal. A digital to analog converter 14 converts the corrective drive signal to analog signal and drives a motor driver 18 to control the spindle rotational speed.

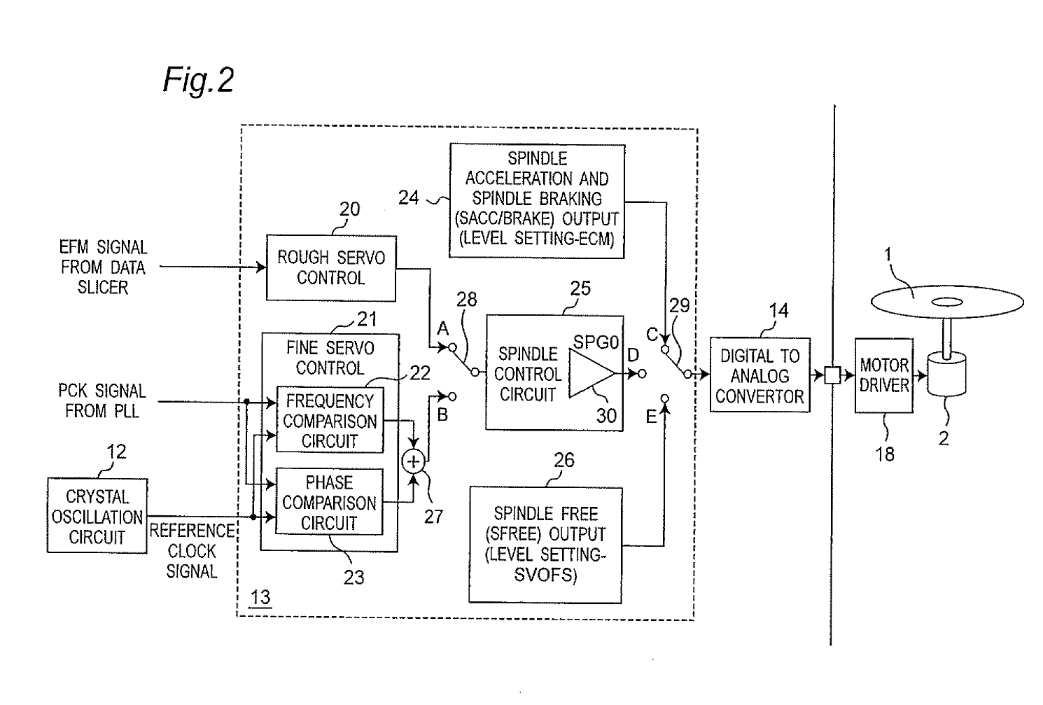

FIG. 2 shows a detail of the spindle servo processing circuit 13. Operation of the spindle servo processing circuit 13 is as follows. The spindle servo processing circuit 13 basically operates in two different modes; servo mode and forced mode. The servo mode is sub-divided into rough servo mode and fine servo mode.

The spindle servo processing circuit 13 includes a rough servo control circuit 20 and a fine servo control circuit 21. The rough servo control circuit 20 controls the spindle rotational speed roughly close to a previously set range (such a range can be selected from a plurality of ranges) by generating a rough corrective signal from EFM signal. The fine servo control circuit 21 makes fine tuning of the spindle rotational speed to a desired speed precisely with reference to the reference clock signal from crystal oscillation circuit 12. The fine servo control circuit 21 has a frequency comparison circuit 22 and a phase comparison circuit 23. The frequency comparison circuit 22 compares the frequency of the PCK signal with the frequency of the reference clock signal and outputting a frequency error signal which represents the speed error with respect to the reference clock signal. The phase comparison circuit 22 performs phase comparison between PCK and reference clock signal thereby generating a phase error signal. The phase error signal represents the synchronization error of the PCK signal with respect to the reference clock signal. The frequency and phase error signal are added by an adder 27 to generate a complete fine corrective signal for spindle servo. When the circuit is functioning under the rough servo mode, a switch 28 is turned to a position shown in FIG. 2 to connect to point A. When the circuit is functioning under the fine servo mode, the switch 28 is turned to connect to point B. A spindle control circuit 25, which includes a SPGO 30 for gain control, receives the spindle corrective signal and produces a digital drive signal to correct the error. An adjustment amount of SPGO 30 set by the system microcomputer 16, is the amount of spindle driving gain during the servo mode operation. A switch 29 is to connect to point D during servo mode so that the output of the spindle control circuit can be fed to the digital to analog converter 14 and the converted analog signal is fed to the motor driver 18 to drive the spindle motor 2.

Under spindle acceleration spindle braking and spindle free-running condition, the spindle servo processing circuit 13 operates in forced mode. During spindle acceleration and spindle braking condition, switch 29 is changed to point C, and during which the spindle acceleration and braking circuit 24 produces a certain level of voltage to execute the operation. The output voltage level will be determined by ECM setting which can be set by the system microcomputer 16. By changing the ECM setting, the acceleration and braking force can be changed. During spindle free running condition, switch 29 is changed to point E, and during which the spindle free-running output circuit 26 produces a certain level of voltage signal to execute the operation. The output voltage level will be determined by SVOFS setting which can be set by the system microcomputer 16. The Digital to Analog converter 14 converts the digital signal to analog signal by which a motor driver 18 is operated to drive the spindle motor 2.

The value of SPGO 30, ECM setting and SVOFS setting can be set correctly depending on the diameter and shape of the loaded optical disk, as it will be described later. Hence, improves the playability and performance of the CD player 100.

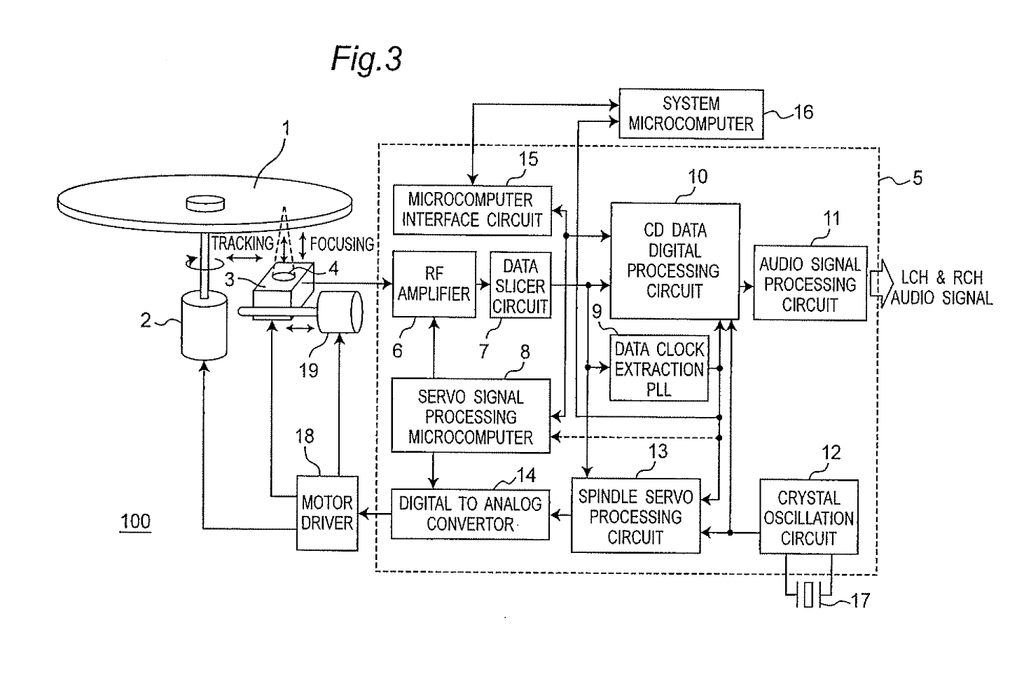

As mentioned, the gain of the spindle control circuit 25, SPGO 30, spindle acceleration/braking force ECM and spindle free-running force SVOFS are set by the system microcomputer 16 in accordance with the diameter and shape of the loaded optical disk. FIG. 3 shows possible methods according the preferred embodiment of the present invention.

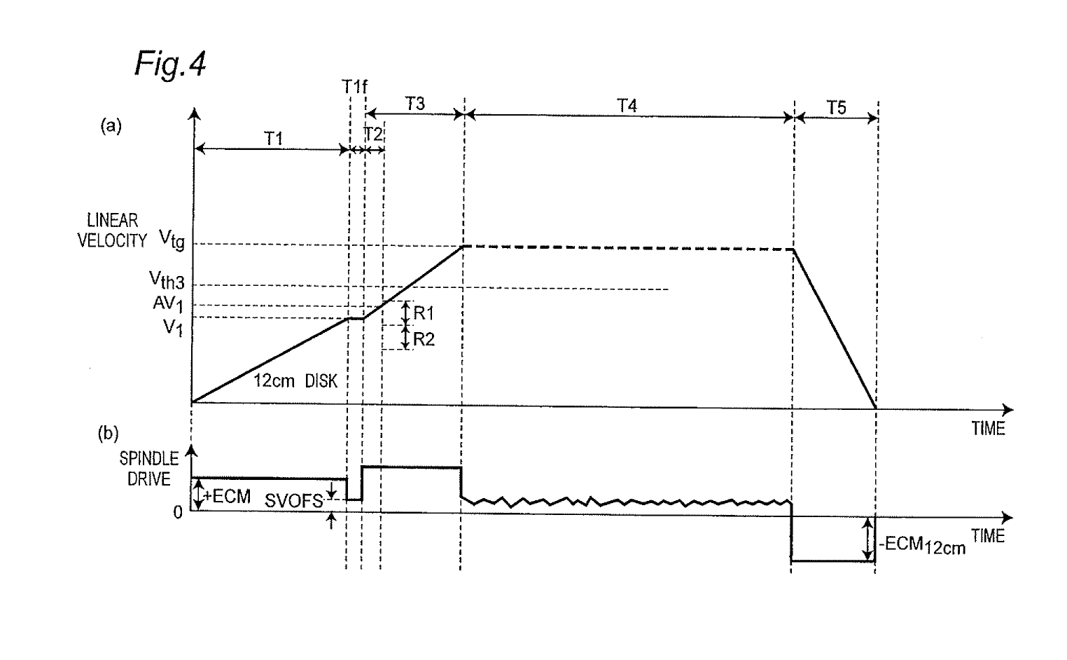

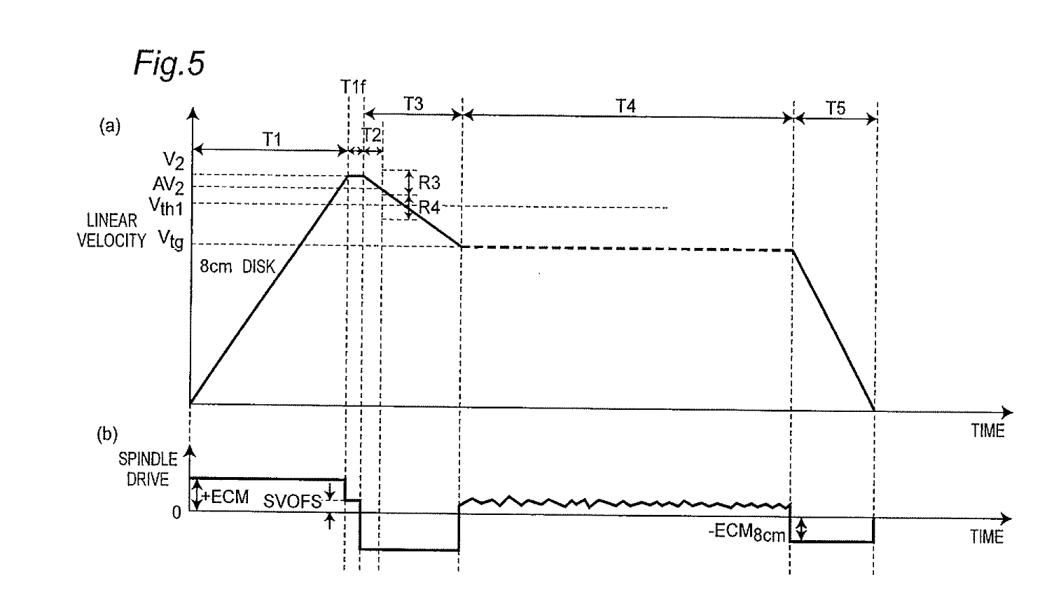

Method 1—The PCK signal from data clock extraction PLL 9 is applied to system microcomputer 16. After accelerating the spindle for a certain period of time T1 (FIGS. 4 and 5), the system microcomputer 16 counts the number of PCK signal for a unit period of time T2 (FIGS. 4 and 5) after the Servo is turned ON and before the spindle locks. This is accomplished by a line connected between the data clock extraction PLL 9 and the system microcomputer 16 in FIG. 3.

Method 2—The counting of the PCK signal is done by servo signal processing microcomputer 8 after the servo is turn ON for a unit period of time and before the spindle locks. The result of the counting is sent to the system microcomputer 16 through the microcomputer interface circuit 15 upon request. This is accomplished by a dotted line connected between the data clock extraction PLL 9 and the servo signal processing microcomputer 8 in FIG. 3.

As explained above, the number of count of the PCK signal represents the rotational speed/linear velocity of the loaded optical disk. Therefore, by accelerating a disk for a certain period of time T1 and then monitoring the PCK signal (rotational speed) before the spindle lock, it is possible to determine the diameter and shape of an optical disk.

FIG. 4(a) shows a linear velocity change of a 12 cm disk, and FIG. 4(b) shows a spindle drive power applied to the spindle motor 2 for rotating the 12 cm disk. Similarly, FIG. 5(a) shows a linear velocity change of an 8 cm disk, and FIG. 5(b) shows a spindle drive power applied to the spindle motor 2 for rotating the 8 cm disk.

As shown in FIG. 4(a), starting from stationary condition, the loaded optical disk is accelerated during a time period T1, a free-running condition is provided during T1f, a rough servo mode is applied during T3, a fine servo mode is applied at during T4 to read the disk at the constant linear velocity (CLV) speed Vtg, and a braking force is applied during T5 to stop the disk.

FIG. 4(b) shows the spindle drive output. During T1, a predetermined acceleration force +ECM is applied. During T1f, an idling power SVOFS is applied to allow the free-running of the disk. At the end of T1f, servo ON command is issued to start the rough servo mode, At the beginning of the rough servo mode, such as during the period T2, the disk speed is compared with a target speed which is a regular disk playing speed. As shown in FIG. 4(a), if the disk speed V1 is less than the target speed Vtg which is a disk speed obtained during the regular disk playing period T4, it is so detected that a 12 cm disk is loaded. In this case, the rough servo control provides a positive force to accelerate the disk to achieve the target speed. On the other hand, as shown in FIG. 5(a), if the disk speed V2 is greater than the target speed Vtg, it is so detected that an 8 cm disk is loaded. In this case, the rough servo control provides a negative force to brake the disk to achieve the target speed. The +value of the spindle drive output represents the acceleration force and the−value represents the braking force. In FIGS. 4(b) and 5(b), the same predetermined acceleration force +ECM is applied during T1 for both 12 cm and 8 cm disks, but for the braking force, −ECM12 cm is applied during T5 for the 12 cm disk, and −ECM8 cm is applied during T5 for the 8 cm disk. This is possible, because the type of the disk is detected after period T2.

According to the present invention, it is possible to further detect whether or not the disk speed V1 is within a first range R1, as shown in FIG. 4(a), or whether or not the disk speed V1 is within a second range R2. If the disk speed V1 is found to be within the first range R1, it is so detected that a regular circle disk of 12 cm size is loaded. If the disk speed V1 is found to be within the second range R2, it is so detected that a square disk of 12 cm size is loaded. Such a range is obtained empirically and by the various settings of the player. Therefore, by detecting the rotational speed of the disk after the initial acceleration, i.e., after period T1 it is not only possible to detect the size of the disk, but also, the shape of the disk.

After the initialization of the OPU 3 position, the loaded disk is accelerated for a certain period of time T1 with the pre-determined acceleration force of +ECM. This acceleration is called an initial acceleration. Due to the differences in disk diameter and shape, the different optical disk will achieve different velocity after the initial acceleration effected during period T1. If a 12 cm disk is loaded, after accelerating for period T1, the disk will achieve velocity V1 if the loaded disk is a 8 cm disk, the velocity after accelerating for period T1 is V2. Since the 12 cm disk is heavier than the 8 cm disk, V2 is higher than V1 (V2>V1).

After accelerating for T1, spindle will enter spindle free-running mode for a short period of time T1f. In spindle free-running mode, the spindle maintains its rotating speed. And then the servo ON command is issued by the system microcomputer 16.

In response to the servo ON command, the spindle servo processing circuit 13 in the DSP 5, starts to function to control the spindle to be at a target linear velocity Vtg. It takes some amount of time T3 to do so. During period T3, the spindle servo is operated under the rough servo mode. Immediately after the servo ON, the counting of the PCK signal starts to detect the disk speed. This is done during a period T2. The number of PCK count in the period T2 is representing the average linear velocity of the loaded optical disk after the initial acceleration of period T1. AV2 and AV1 are the average linear velocity after the initial acceleration of period T1 for 8 cm disk and 12 cm disk, respectively. The average linear velocities AV2 and AV1 are obtained by the PCK counting results PCK-AV2 and PCK-AV1, respectively, by system microcomputer 16 after the counting period of T2. The counting results PCK-AV2 and PCK-AV1 are used to determine the size and shape of the loaded optical disk.

It is to be noted that the detection of the average linear velocity is done after the initial acceleration, and even after the free-running mode, as explained above, or before or during the free-running mode.

PCK-Vtg is the PCK count at the target linear velocity Vtg. By setting the PCK-Vtg as a reference value, the number of PCK count in period T2 is compare with PCK-Vtg by the system microcomputer 16. If the number of PCK count is greater than PCK-Vtg (for example PCK-AV2), the system microcomputer 16 detects that the loaded disk is a 8 cm disk If the number of PCK count is less than PCK-Vtg (for example PCK-AV1), the system microcomputer 16 detects that the loaded disk is a 12 cm disk. After the detecting of the disk size, SPGO 30, ECM setting and SVOFS setting are set according to the diameter of the disk. Once set, the latest value settings will be used until the disc is ejected. When a new disk is loaded, the detection of the disk size need to be redo once again.

In the above example, the disk size is detected by a comparison of the detected disk speed, which is the PCK count, with a target disk speed, which is PCK-Vtg. It is possible to detect the disk size by detecting the range in which the detected disk speed falls into. For example, if the detected disk speed falls into range R1, it is so detected that the loaded disk is a 12 cm disk, and if the detected disk speed falls into range R3, it is so detected that the loaded disk is an 8 cm disk.

Furthermore, such ranges can be used for detecting the shape of the disk. For example, if the detected disk speed falls into range R1, it is so detected that the loaded disk is a circle 12 cm disk, and if the detected disk speed falls into range R2, it is so detected that the loaded disk is a square 12 cm disk. Similarly, if the detected disk speed falls into range R3, it is so detected that the loaded disk is a circle 8 cm disk, and if the detected disk speed falls into range R4, it is so detected that the loaded disk is a square 8 cm disk,

According to the present invention, it is possible to distinguish a size of a disk from among different sizes, such as 8 cm disk and 12 cm disk, or any other available sizes. Also, a shape of a disk can be distinguished from among different shapes, such as circle, heart, square, rectangular, triangle, or any other polygons. For example, PCKth1 and PCKth3 reference values representing the linear velocities Vth1 and Vth3, respectively, may be compared with PCK-Vtg in period T2 to determine the suitable gain setting. The plural reference values have an advantage of providing a fine and more precise system in making decision with different diameter and shape of disk.

In the above-described embodiment, the PCK signal which represent the EFM data clock signal is used to indicate the spinning speed of the spindle. Alternatively, any other signal there is able to indicate the spinning speed of the spindle may be utilized also. Although the embodiment above is applied to the CD player 100 playing back the CD 1, this is not the limitation of this invention. This invention is also produce the effective result when applied to other kind of disk drive.

What is claimed is:

1. A method for detecting a disk size of an optical disk mounted on a spindle, comprising:
accelerating the optical disk on the spindle for a predetermined period of time;
detecting a speed of a disk by using a data clock signal produced by reading data on the disk after said accelerating;
comparing the disk speed with a predetermined speed; and
detecting the disk size by a result of the comparison.

2. The method according to claim 1, wherein the accelerating is effected at a predetermined force.

3. The method according to claim 1, wherein the detecting is carried out such that, if the disk speed is greater than the predetermined speed, the disk is detected as an 8 cm disk, and if the disk speed is less than the predetermined speed, the disk is detected as a 12 cm disk.

4. The method according to claim 1, further comprising issuing a servo ON command after the accelerating and before the detecting.

5. The method according to claim 1, wherein the detecting is effected by counting the frequency of data clock signal.

6. The method according to claim 5, wherein the counting is carried out by an external system microcomputer using a counting signal produced from a digital signal processor.

7. The method according to claim 5, wherein the counting is carried out by a servo signal processing unit, and the counting result is sent to an external system microcomputer.

8. The method according to claim 1, wherein the detecting detects disk diameter.

9. The method according to claim 1, wherein the detecting detects disk shape.

10. The method according to claim 1, wherein the detecting is carried out by comparing the disk speed with a regular disk playing speed.

11. The method according to claim 1, wherein the detecting is carried out by finding one of a plurality of ranges in which the disk speed falls in.

12. An apparatus for detecting a disk size of an optical disk mounted on a spindle, comprising:
an accelerating device operable to accelerate the optical disk on the spindle for a predetermined period of time;
a first detecting device operable to detect a speed of a disk by using a data clock signal produced by reading data on the disk after accelerating;
a comparing device operable to compare the disk speed with a predetermined speed; and
a second detecting device operable to detect the disk size by a result of the comparison.

13. The apparatus according to claim 12, wherein the accelerating device has a computer by which accelerating is effected at a predetermined force.

14. The apparatus according to claim 12, wherein the second detecting device carries out the detection such that, if the disk speed is greater than the predetermined speed, the disk is detected as an 8 cm disk, and if the disk speed is less than the predetermined speed, the disk is detected as a 12 cm disk.

15. The apparatus according to claim 12, further comprising an issuing device operable to issuing a servo ON command after the accelerating and before the detecting.

16. The apparatus according to claim 12, wherein the first detecting device has a computer operable to count the frequency of data clock signal.

17. The apparatus according to claim 16, wherein the computer is an external system microcomputer which counts a clock signal produced from a digital signal processor.

18. The apparatus according to claim 16, wherein the computer is a servo signal processing microcomputer which counts a clock signal, and the counted result being sent to an external system microcomputer,

19. The apparatus according to claim 12, wherein the second detecting device detects disk diameter.

20. The apparatus according to claim 12, wherein the second detecting device detects disk shape.

21. The apparatus according to claim 12, wherein the second detecting device is operable to comparing the disk speed with a regular disk playing speed.

22. The apparatus according to claim 12, wherein the first detecting device is operable to find one of a plurality of ranges in which the disk speed falls in.
